(19) United States
(12) Patent Application Publication
(10) Pub. No.: US 2009/0200153 A1
(43) Pub. Date: Aug. 13, 2009

(54) Method for producing and dehydrating cyclic formals

(75) Inventors: Reinhard Wagener, Hofheim (DE); Michael Haubs, Bad Kreuznach (DE); Juergen Lingnau, Mainz-Laubenheim (DE); Matthias Göring, Hofheim (DE); Michael Hoffmockel, Niedernhausen (DE)

Correspondence Address: CONNOLLY BOVE LODGE & HUTZ, LLP, P O BOX 2207, WILMINGTON, DE, 19899, US

(73) Assignee: TICONA GmbH, Kelsterbach (DE)

(21) Appl. No.: 11/665,047

(22) PCT Filed: Oct. 6, 2005
(86) PCT No.: PCT/EP2005/010761

§ 371 Date: May 17, 2007

(30) Foreign Application Priority Data
Oct. 8, 2004 (DE) 10 2004 049 056.2

(51) Int. Cl. B01D 61/36

(52) U.S. Cl. 203/17

(57) ABSTRACT

Processes are described which comprise: (a) providing a mixture comprising a cyclic formal and water, wherein the mixture has a cyclic formal concentration and a water concentration; (b) bringing the mixture into contact with an aqueously selective membrane; (c) creating a pressure differential across the membrane; and (d) obtaining a permeate having a higher water concentration and a lower cyclic formal concentration than the mixture, and a retentate having a lower water concentration and a higher cyclic formal concentration than the mixture.

The invention relates to a process for preparing anhydrous cyclic formals.

Cyclic formals can be prepared by acid-catalyzed reaction of dihydric alcohols (dialcohols) and formaldehyde. The industrially most important cyclic formal is 1,3-dioxolane (dioxolane). It is prepared industrially by acid-catalyzed reaction of aqueous formaldehyde with ethylene glycol. Dioxolane can be removed from the reaction mixture by distillation, but is always accompanied by water because the two components form an azeotrope with approx. 93% by weight of dioxolane. For the solution of this separation problem, numerous processes have been proposed, most of which utilize extraction or extractive rectification in order to overcome the azeotropic point of the water/dioxolane mixture.

U.S. Pat. No. 5,690,793 and U.S. Pat. No. 5,695,615 disclose processes for purifying cyclic formals in which water is removed in an extractive distillation with polar nonvolatile solvents.

U.S. Pat. No. 5,456,805 describes the separation of dioxolane and water from the reaction of formaldehyde with ethylene glycol by extractive distillation with n-pentane.

DE 1 279 025 teaches the separation of dioxolane and water from the reaction of formaldehyde with ethylene glycol by extractive distillation with alkaline aqueous solutions.

BE 669 480 discloses a process for extraction of dioxolane from aqueous mixtures with chlorinated hydrocarbons and subsequent alkaline scrubbing of the crude dioxolane.

JP 07 285958 teaches a process in which the azeotrope of water and dioxolane is extracted with hydrocarbons in the liquid phase and then the organic phase is distilled to give the pure dioxolane.

In DE 38 85 882 T2, a membrane comprising a separating layer composed of crosslinked polyvinyl alcohol is used to separate an alcohol from an oxygen-containing substance. This document does not give any indication to a corresponding use for removing cyclic formals from aqueous mixtures.

The prior art processes are in need of improvement because, as well as water and cyclic formals, they introduce a third substance into the process as an extractant or azeotroping agent. This third substance normally has to be purified in a separate cycle in order to be able to be used again. If this does not succeed completely, partial disposal of the third substance leads to complicated subsequent purification or to pollution of the environment. In any case, the additional separating operations require additional energy for their operation.

There is therefore a need for a process for preparing anhydrous cyclic formals which does not require a third substance as an extractant or azeotroping agent;
which does not present any disposal problems in the case of the incomplete recovery of the third substance;
and which works with reduced energy consumption.

It has been found that, surprisingly, pervaporation or vapor permeation of cyclic formals, especially of 1,3-dioxolane, and water with suitable aqueously selective membranes affords very good separation factors and high permeate flows. The membrane separation of cyclic formals from water can also be operated at elevated temperatures with further enhanced permeate flows.

The invention therefore provides a process for removing cyclic formals, especially 1,3-dioxolane, from mixtures with water, which comprises
a) contacting the mixture comprising cyclic formal and water with an aqueously selective membrane,
b) applying a pressure difference over the membrane and
c) obtaining, on the permeate side of the membrane, a product which has a higher concentration of water and a lower concentration of cyclic formal than the starting mixture.

The invention further provides a process for removing cyclic formals, especially 1,3-dioxolane, from mixtures with water, which comprises
a) enriching a mixture of cyclic formal and water to close to the azeotropic concentration,
b) feeding a cyclic formal-enriched, liquid mixture from step a) to an aqueously selective pervaporation membrane,
c) obtaining from pervaporation a liquid retentate having a higher content of cyclic formal and a vaporous, water-rich permeate.

In another embodiment of the invention, the membrane separation is not performed as a pervaporation with a liquid feed but rather as a vapor permeation with a vaporous starting mixture of the cyclic formal with water.

The invention therefore further provides a process for removing dioxolane and other cyclic formals from mixtures with water, which comprises
a) enriching a mixture of cyclic formal and water to close to the azeotropic concentration,
b) feeding a cyclic formal-enriched, vapor mixture from step a) to an aqueously selective vapor permeation membrane,
c) obtaining from vapor permeation a vaporous retentate having a higher content of cyclic formal and a vaporous, water-rich permeate.

Cyclic formals are obtained in a cyclization reaction from dialcohols and formaldehyde. Typical representatives are 1,3-dioxolane (from ethylene glycol), 1,3-dioxepane (from 1,4-butanediol), diethylene glycol formal, 4-methyl-1,3-dioxolane (from 1,2-propanediol), 1,3-dioxane (from 1,3-propanediol), 4-methyl-1,3-dioxane (from 1,3-butanediol) and 1,3,5-trioxepane (from ethylene glycol and two molecules of formaldehyde). Preference is given to 1,3-dioxolane.

Suitable catalytically active acids are, for example, mineral acids such as sulfuric acid, phosphoric acid, or aliphatic or aromatic sulfonic acids such as methanesulfonic acid, trifluoromethanesulfonic acid, benzenesulfonic acid, toluenesulfonic acid, naphthalenesulfonic acid, or else highly acidic ion exchange resins or heteropolyacids such as polyphosphoric acid, tungstophosphoric acid or molybdophosphoric acid.

The reaction can be conducted according to the prior art in a stirred tank reactor with attached distillation column or as a reactive distillation column. The mixture of cyclic formal and water obtained at the top of this column already contains more than 30% by weight, preferably more than 40% by weight and more preferably more than 50% by weight of cyclic formal. In addition to the cyclic formal and water, the mixture may also comprise other constituents of the reaction mixture, such as dialcohol or formaldehyde, in small concentrations.

In a preferred embodiment of the invention, the feed mixture consisting essentially of cyclic formal and water is obtained as a distillate or exhaust vapor from the reaction of a dialcohol with formaldehyde under acidic catalysis.

The invention therefore provides a process for preparing cyclic formals from dialcohols and formaldehyde, which comprises
a) reacting the dialcohol and the formaldehyde with catalysis by a suitable acid,
b) decompressing a vaporous mixture essentially comprising the cyclic formal and water out of the reaction vessel,
c) enriching the mixture of cyclic formal obtained in step b) to close to the azeotropic concentration,
d) feeding a cyclic formal-enriched, liquid mixture from step c) to an aqueously selective pervaporation membrane,
e) obtaining from the pervaporation a liquid retentate with a higher content of cyclic formal and a vaporous, water-rich permeate.

In a particularly preferred embodiment of the invention, the vaporous mixture from step b) is not condensed, but rather fed as vapor to an aqueously selective vapor permeation membrane. This procedure is particularly advantageous with regard to the evaporation energy to be applied, because it utilizes the energy content of the exhaust vapor from the reaction vessel.

The invention therefore further provides a process for preparing cyclic formals from dialcohols and formaldehyde, which comprises
a) reacting the dialcohol and the formaldehyde with catalysis by a suitable acid,
b) decompressing a vaporous mixture essentially comprising the cyclic formal and water out of the reaction vessel,
c) enriching the mixture of cyclic formal obtained in step b) to close to the azeotropic concentration,
d) feeding a cyclic formal-enriched, vapor mixture from step c) to an aqueously selective vapor permeation membrane,
e) obtaining from the vapor permeation a vaporous retentate with a higher content of cyclic formal and a vaporous, water-rich permeate.

The mixture of cyclic formal and water can be enriched to the azeotrope concentration by conventional rectification, in which case a water stream forms as well as the enriched mixture. In a preferred embodiment of the invention, the enrichment of the cyclic formal to the azeotrope is performed in a membrane separation (pervaporation or vapor permeation) with an organically selective membrane. In a preferred embodiment of the invention, the cyclic formal is enriched to more than 80%, preferably more than 90%, of the azeotropic concentration, before it is fed to the inventive membrane process in step d). In the case of the preferred dioxolane, the concentration in the feed to the membrane is preferably more than 80% by weight and more preferably more than 90% by weight.

For the process according to the invention, membranes which allow water to permeate preferentially over organic components are used. Suitable membranes for the process according to the invention may be used equally in the pervaporation procedure with liquid membrane feed and in the vapor permeation procedure. In a preferred embodiment, the separation-active layer of the membrane consists of poly(vinyl alcohol) (PVOH), which is obtained from poly(vinyl acetate) by more or less complete hydrolysis. Such membranes are commercially available.

The separation-active layer of the membrane has a thickness of 1-200 μm, preferably 2-50 μm and more preferably 4-10 μm.

The separation factor α of the membrane process depends upon the selectivity of the membrane and the pressure ratio over the membrane. The separation factor α of the membrane process can be determined experimentally as follows:

α=(yₚ/xₚ)/(y_{f}/x_{f})

where:
yₚ=proportion by mass of the cyclic formal in the permeate
xₚ=proportion by mass of the water in the permeate
y_{f}=proportion by mass of the cyclic formal in the feed
x_{f}=proportion by mass of the water in the feed

The separation factor α depends greatly on the composition of the feed and typically rises greatly with increasing concentration of the cyclic formal in the feed. For example, α=30 for a dioxolane concentration of 50% by weight in the feed, α=170 for a dioxolane concentration of 85% by weight in the feed and α=1000 for a dioxolane concentration of 98% by weight in the feed (at a temperature of 70° C., commercial membrane from Sulzer, type 2201).

The permeation rate of the membrane depends firstly upon the structure of the membrane, for instance—within certain limits—upon the thickness of the separation-active layer; but secondly also upon the operating conditions of the membrane process. For instance, the permeation rate falls with increasing concentration of the cyclic formal in the feed, but on the other hand rises with increasing temperature of the feed and rises with increasing pressure ratio over the membrane. According to the invention, the permeation rate through the membrane is between 0.1 kg/m²/h and 50 kg/m²/h, preferably between 0.5 kg/m²/h and 25 kg/m²/h and more preferably between 1 kg/m²/h and 10 kg/m²/h.

To perform the inventive removal of cyclic formals, especially of 1,3-dioxolane, a pressure difference is applied over the membrane. This is typically done by applying a reduced pressure on the permeate side of the membrane. However, the pressure difference can also be increased by increasing the partial pressure of the water on the feed side of the membrane. The pressure ratio over the membrane is between 2 and 500, preferably between 5 and 50.

A particular advantage of the process is that good separating performances are achieved even with a heated feed. It is known to those skilled in the art that pervaporation membranes are swollen at elevated temperatures by polar aprotic solvents such as the cyclic formals and can loose their selectivity. In the process according to the invention, separation factors of α>10, preferably α>20, are still achieved even at feed temperatures of T≧40° C. In a preferred embodiment of the invention, the feed to the pervaporation or vapor permeation membrane is adjusted to a temperature of T>40° C.

In a preferred embodiment of the invention, the retentate has a content of cyclic formal of over 99% by weight, more preferably over 99.5% by weight. For particularly high purity requirements, the cyclic formal thus obtained can be worked up to the desired purity in further separation steps.

In a preferred embodiment of the invention, the composition of the aqueous permeate is over 70% by weight of water and more preferably over 90% by weight of water.

Further preferred embodiments of the invention are evident from the subclaims.

### EXAMPLE 1

A mixture of 50% by weight of dioxolane and 50% by weight of water which has been adjusted to a temperature of 75° C. is fed in pumped circulation to a pervaporation test cell. The test cell is equipped with a PVOH membrane (Sulzer, type 2211). In the permeate space, a pressure of 10 mbar absolute is established. The permeate is condensed in a cold trap at −15° C. Once steady-state conditions have been established, the cold trap is changed and an analysis of the permeate which is then obtained is performed. 3.3% by weight of dioxolane is obtained, corresponding to a separation factor of α=30. The permeation rate through the membrane was 4.8 kg/m²/h.

### EXAMPLE 2

Example 1 was repeated identically, but with 85% by weight of dioxolane in the feed. The permeation rate was 4.2 kg/m²/h and the dioxolane concentration in the permeate was 3.9% by weight.

### EXAMPLE 3

Example 1 was repeated identically, but with 98% by weight of dioxolane in the feed. The permeation rate fell to 2.1 kg/m²/h and the dioxolane concentration was 5.1% by weight.

### EXAMPLE 4

Example 1 was repeated identically, but the feed temperature was 55° C. The permeation rate fell to 2 kg/m²/h and the dioxolane concentration was 3.5% by weight.

1-25. (canceled)

26. A process comprising:
(a) providing a mixture comprising a cyclic formal and water, wherein the mixture has a cyclic formal concentration and a water concentration;
(b) bringing the mixture into contact with an aqueously selective membrane;
(c) creating a pressure differential across the membrane; and
(d) obtaining a permeate having a higher water concentration and a lower cyclic formal concentration than the mixture, and a retentate having a lower water concentration and a higher cyclic formal concentration than the mixture.

27. The process according to claim 26, further comprising enriching the mixture up to its azeotropic concentration prior to bringing the mixture into contact with the membrane.

28. The process according to claim 26, further comprising enriching the mixture to at least 80% of its azeotropic concentration prior to bringing the mixture into contact with the membrane.

29. The process according to claim 26, wherein the mixture is provided as a liquid, and wherein the membrane comprises a pervaporation membrane.

30. The process according to claim 26, wherein the mixture is provided as a vapor, and wherein the membrane comprises a vapor permeation membrane.

31. The process according to claim 27, wherein the mixture is provided as a liquid, and wherein the membrane comprises a pervaporation membrane.

32. The process according to claim 27, wherein the mixture is provided as a vapor, and wherein the membrane comprises a vapor permeation membrane.

33. The process according to claim 26, wherein the mixture comprises a product obtained by reacting a dialcohol and formaldehyde in the presence of a suitable acidic catalyst.

34. The process according to claim 33, wherein the suitable acidic catalyst comprises one or more materials selected from the group consisting of sulfuric acid, phosphoric acid, aliphatic sulfonic acids, aromatic sulfonic acids, strongly acidic ion exchange resins, heteropolyacids, and mixtures thereof.

35. The process according to claim 29, wherein the mixture comprises a liquid product obtained by reacting a dialcohol and formaldehyde in the presence of a suitable acidic catalyst to form an initial product, and condensing the initial product.

36. The process according to claim 26, wherein the cyclic formal comprises at least one selected from the group consisting of 1,3-dioxolane, 1,3-dioxepane, diethylene glycol formal, 4-methyl-1,3-dioxolane, 1,3-dioxane, 4-methyl-1,3-dioxane, 1,3,5-trioxepane, and mixtures thereof.

37. The process according to claim 26, wherein the cyclic formal comprises 1,3-dioxolane.

38. The process according to claim 37, wherein the cyclic formal concentration of the mixture is greater than 80% by weight.

39. The process according to claim 26, wherein the membrane comprises a hydrophilic polymer.

40. The process according to claim 39, wherein the hydrophilic polymer comprises a polyvinylalcohol.

41. The process according to claim 26, wherein the membrane comprises a separation-active layer having a thickness of 1-200 μm.

42. The process according to claim 41, wherein the separation-active layer comprises a hydrophilic polymer.

43. The process according to claim 26, wherein the process has a separation factor α greater than 5.

44. The process according to claim 26, wherein the mixture is brought into contact with the membrane at a temperature greater than 40° C.

45. The process according to claim 26, wherein the cyclic formal concentration of the retentate is greater than 99% by weight.
